(19) United States
(12) Patent Application Publication
(10) Pub. No.: US 2005/0031054 A1
(43) Pub. Date: Feb. 10, 2005

(54) Digital communication device and digital communication system

(75) Inventor: Koji Horisaki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/750,818

(22) Filed: Jan. 5, 2004

(30) Foreign Application Priority Data
Aug. 7, 2003 (JP) 2003-289013

(51) Int. Cl. H04L 27/06

(52) U.S. Cl. 375/341

(57) ABSTRACT

A digital communication device, comprising: decoder which calculates likelihoods indicative of probability in which a signal received from another communication corresponds to a plurality of signal sequences; a relative likelihood calculator which calculates a relative likelihood expressing differences and ratios between the most probable likelihood among the calculated likelihoods and the other likelihoods; and a transmission parameter deciding unit which decides a transmission parameter composed of at least one of modulation scheme, a coding rate and a transmission power for a signal to be transmitted at next time, based on the calculated relative likelihood.

### CROSS REFERENCE TO RELATED APPLICATIONS

This application claims benefit of priority under 35USC§119 to Japanese Patent Application No. 2003-289013, filed on Aug. 7, 2003, the entire contents of which are incorporated by reference herein.

### BACKGROUND OF THE INVENTION

1. Field of the Invention

The present invention relates to a digital communication device capable of changing a transmission parameter such as a modulation scheme, a coding rate and a transmission power. For example, the present invention intends a technique used for a wireless LAN (Local Area Network) and so on.

2. Related Background Art

A digital communication device capable of changing a transmission parameter such as a coding rate and a transmission power has been known, for example, in Japanese Patent Laid-Open No. 174428/2003. In the document, as received electric intensity of a received signal is weak, the modulation scheme strong against noise is selected and the coding rate is decreased. Therefore, it is possible to stabilize communication quality and improve effective speed of data transmission. Conversely, when the received electric intensity is strong, the modulation scheme weak against noise is selected and the coding rate is increased.

Even if the received electric field is strong, however, there is a case where signal waveform is distorted. In such a case, a bit error rate is not necessarily improved. Accordingly, it is undesirable to uniformly decide the modulation scheme and the coding rate based on only the received electric intensity.

In the above-mentioned document, differences of performance of a transmitter and a receiver and compatibility are not taken into consideration. Practically, transmission throughput is largely influenced by differences of the performance and the compatibility.

### SUMMARY OF THE INVENTION

A digital communication device according to one embodiment of the present invention, comprising:
a decoder which calculates likelihoods indicative of probability in which a signal received from another communication device corresponds to a plurality of signal sequences;
a relative likelihood calculator which calculates as relative likelihood expressing differences and ratios between the most probable likelihood among the calculated likelihoods and the other likelihoods; and
a transmission parameter deciding unit which decides a transmission parameter composed of at least one of modulation scheme, a coding rate and a transmission power for a signal to be transmitted at next time, based on the calculated relative likelihood.

Furthermore, a digital communication system according to one embodiment of the present invention comprising first and second communication devices which transmit and receive a signal to each other through first and second communication channels, wherein at least one of said first and second communication devices includes:
a first decoder which calculates a likelihood indicative of a probability in which a signal received from another communication device corresponds to candidates of a plurality of signal sequences, respectively;
a relative likelihood calculator which calculates a relative likelihood expressing differences and ratios between the most probable likelihood among the calculated likelihoods and other likelihoods; and
a transmission parameter deciding unit which decides a transmission parameter composed of at least one of modulation scheme, a coding rate and a transmission power of a signal to be transmitted to a second communication device at next time.

### BRIEF DESCRIPTION OF THE DRAWINGS

FIG. 1 is a block diagram showing a schematic configuration of the digital communication system according to the first embodiment of FIG. 1.

FIGS. 2A and 2B are diagrams which explain an example of a more detailed operation of the relative likelihood calculator 10, the modulation scheme selector 5, the coding rate selector 6 and the transmission power selector 7.

FIG. 3 is a block diagram showing a schematic configuration of the digital communication system according to the second embodiment of the present invention.

### DESCRIPTION OF THE PREFERRED EMBODIMENTS

Hereinafter, a digital communication device and a digital communication system according to the present invention will be more specifically described with reference to drawings.

### First Embodiment

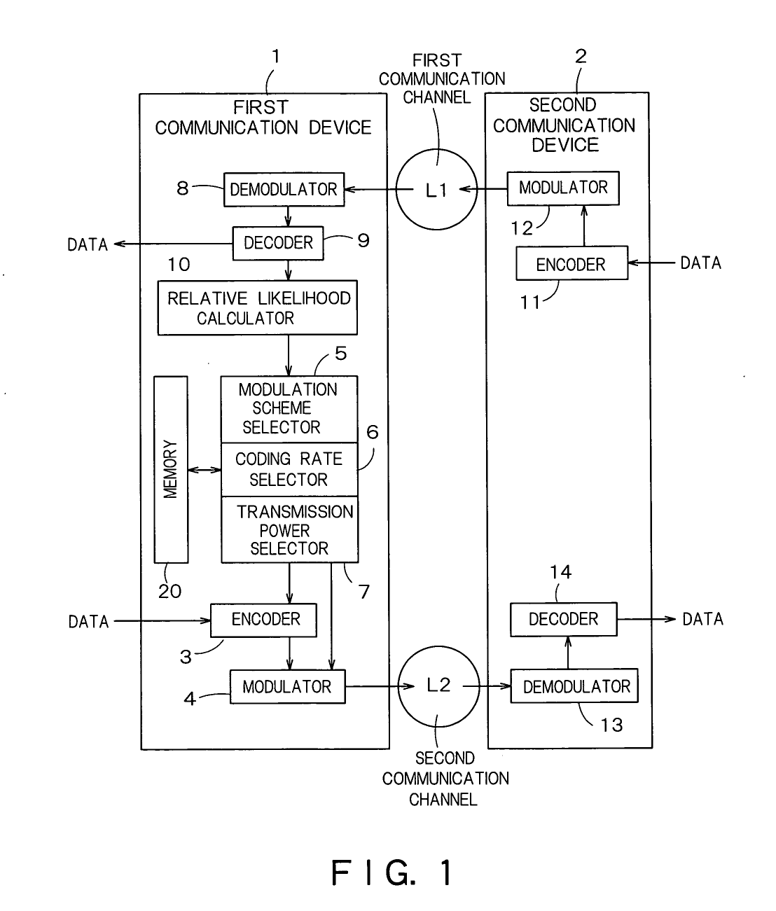

FIG. 1 is a block diagram showing schematic configuration of a digital communication system according to a first embodiment of the present invention. The digital communication system of FIG. 1 has first and second communication apparatuses 1 and 2 which transmit and receive data through first and second communication channels L1 and L2.

The first communication channel L1 transmits data from the second communication device 2 to the first communication device 1. The second communication channel L2 transmits data from the first communication device 1 to the second communication device 2. The first and second communication channels L1 and L2 may be provided separately as shown in FIG. 1, or the same communication channel may be shared for transmission and reception.

The first communication device 1 has an encoder 3 which carries out error correction coding for the transmission data to generate coding data, a modulator 4 which modulates data coded by the encoder 3 into transmission data suitable for the second communication channel L2, a modulation scheme selector 5 which selects the modulation scheme of the transmission data, a coding rate selector 6 which selects the coding rate of the coding data, a transmission power selector 7 which sets the transmission power of the transmission data, a demodulator 8 which demodulates data received through the first communication channel L1 to generate demodulation data, a decoder 9 which decodes original data from the demodulation data, and a relative likelihood calculator 10.

The second communication device 2 has an encoder 11 which carries out error correction coding for the transmission data to generate the coding data, a modulator 12 which modulates the coding data into the transmission data suitable for the first communication channel L1, a demodulator 13 which demodulates data received through the second communication channel L2 to generate the demodulation data, and a decoder 14 which decodes original data from the demodulation data.

The demodulator 9 in the first communication device 1 calculates likelihoods for a plurality of candidate sequences, respectively and selects the most probable sequence to extract the received data. The decoder 9 supplies the likelihoods for a plurality of candidate sequences, to the relative likelihood calculator 10.

The relative likelihood calculator 10 calculates the sequence with the highest likelihood. That is, the relative likelihood calculator 10 calculates more than at least one of differences and ratios between the likelihood of the most probable sequence relating to the receiving data and the likelihoods of the other sequences, as the relative likelihoods. The calculated relative likelihoods are supplied to at least one of the coding rate selector 6 and the transmission power selector 7.

The modulation scheme selector 5 selects the modulation scheme in which transmission speed is high at next transmission time when the relative likelihoods are higher than a threshold value prescribed in advance, and selects the modulation scheme in which transmission speed is low at next transmission time when the relative likelihood is smaller than the threshold value prescribed in advance.

What the relative likelihood is large means that distortion of the transmitter in the second communication device 2, the distortion of the receiver in the first communication device 1, and the distortion and the noise at the communication channel which exists between the first and second communication devices 1 and 2 are in good condition in total.

Generally, the modulation scheme with the small amount of transmission is strong against distortions of the transmitter, the receiver and the communication channel and the noise. Conversely, the modulation scheme with the large amount of transmission is weak against the distortion and the noise. When the distortion and the noise exist, reception error may occur.

For example, BPSK (Binary Phase Shift Keying), QPSK (Quadrate Phase Shift Keying), 16 QAM (16 Quadrate Amplitude Modulation) and 64 QAM (64 Quadrate Amplitude Modulation) are used as the modulation schemes. The transmission speed is BPSK<QPSK<16 QAM<64 QAM. Tolerance for the distortion and the noise is BPSK>QPSK>16 QAM>64 QAM.

The modulation system selector 5 selects the modulation system in which the tolerance for the distortion and the noise is low and the amount of transmission is large, i.e. high data rate, when the distortion and the noise are small. The modulation scheme in which the amount of transmission is small, i.e. low data rate, but the tolerance for the distortion and the noise is good can be selected. Therefore, transmission throughput can be improved.

Similarly, the coding rate selector 6 selects a high coding rate at next transmission time when the relative likelihood is larger than the threshold value prescribed in advance, and selects a low coding rate at next transmission time when the relative likelihood is smaller than the threshold value prescribed in advance.

Generally, the high coding rate means that the amount of data transmission is large. However, the high coding rate is weak to the distortion and the noise, and the received error may occur. Conversely, the low coding rate is strong against the distortion and the noise, even if the amount of data transmission is small.

A convolution code is a coding method often used for a general communication system. The coding rate ½, ⅔ and ¾ are often used as the coding rate. The amount of transmission is ½<⅔<¾. The tolerance for the distortion and the noise is ½>⅔>¾.

Accordingly, the coding rate selector 6 selects the coding rate in which the tolerance for the distortion and the noise is low and the amount of transmission is large, i.e. high data rate, when the distortion and the noise are small, and selects the coding rate in which the amount of transmission is small, i.e. low data rate, and there is few likelihood of error even if the distortion and the noise exist.

The transmission power selector 7 selects small transmission power at next transmission time when the relative likelihood is larger than the threshold value prescribed in advance, and selects large transmission power at next transmission time when the relative likelihood is smaller than the threshold value prescribed in advance. Generally, the smaller the transmission power becomes, the smaller power consumption of the transmitter becomes. However, because SNR (Signal to Noise Ratio) of the receiver becomes small, the received error may occur. Conversely, when the transmission power becomes large, the power consumption of the transmitter increases. However, the larger the SNR of the receiver becomes, the lower probability of the received error becomes.

Therefore, there is a request which want to decrease the transmission power at a range where the received error does not occur in the receiver. As shown in the present embodiment, if the transmission power is selected in accordance with the relative likelihood, it is possible to select the transmission power suitable for the request. When the transmission power is increased at wireless communication, interference for the other communication station in the same communication system or the other wireless system may increase. According to the present embodiment, because the transmission power is controlled if necessary, without lowering communication quality of itself, it is possible to suppress the interference for the other system.

In the above-mentioned explanation, an example in which the modulation scheme, the coding rate and the transmission power are independently selected has been described. Two or more combinations of the modulation scheme, the coding rate and the transmission power may be selected together. More specifically, there are a combination A composed of “the modulation system is BPSK, the coding rate is ½, and the transmission power is −10 dBm” a combination B composed of “the modulation scheme is QPSK, the coding rate is ¾, and the transmission power is −15 dBm”, and a combination C composed of “the modulation scheme is 64 QAM, the coding rate is ⅔, and the transmission power is −20 dBm”. A threshold value 1 for discriminating the combinations A and B, and a threshold value 2 for discriminating the combinations B and C, which is larger than the threshold value 1 is prescribed in advance. If the relative likelihood is larger than the threshold value 2, the combination C is selected. If the relative likelihood is larger than the threshold value 1 and less than the threshold value 2, the combination B is selected. If the relative likelihood is 1 or less, the combination A is selected.

Thus, a plurality of combinations of the modulation scheme, the coding rate and the transmission power are prepared. If one of these combinations is selected, the modulation scheme, the coding rate and the transmission power can be selected together. Therefore, it is possible to simplify configuration of the communication device, and to improve transmission throughput. When there is a request for notifying a communication destination of the modulation scheme, the coding rate and the transmission output, it is possible to reduce the amount of notification necessary for the notification and to improve substantial throughput.

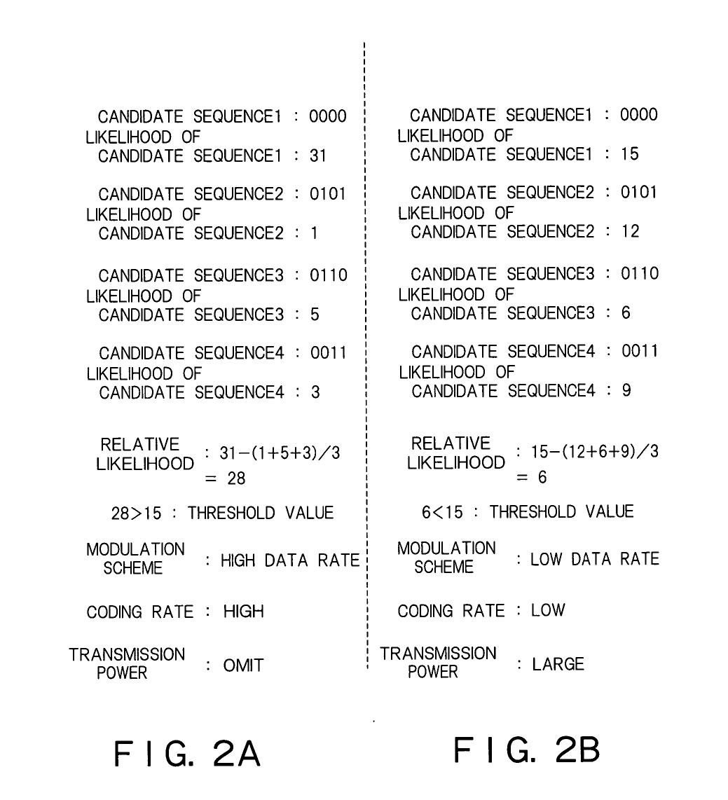

FIG. 2A and 2B are diagrams for explaining one example of more detailed operations of the relative likelihood calculator 10, the modulation scheme selector 5, the coding rate selector 6 and the transmission power selector 7. FIGS. 2A and 2B show an example different from each other. FIGS. 2A and 2B show examples in which the likelihood of the candidate sequence 1 is the biggest and the candidate sequence 1 is selected.

Because the likelihood “31” of the candidate sequence 1 in FIG. 2A is larger than an average value 31−(1+5+3)/3=28 of the likelihoods in the other candidate sequences 2-4, the modulation scheme selector 5 selects the modulation scheme with the large amount of transmission, the coding rate selector 6 selects a high coding rate, and the transmission power selector 7 decreases the transmission power.

Because the likelihood “15” of the candidate sequence 1 in FIG. 2B is larger than the average value 15−(1+5+3)/3=28 of the likelihoods in the other candidate sequences 2-4, the modulation scheme selector 5 selects the modulation scheme with the small amount of transmission, the coding rate selector 6 selects a low coding rate, and the transmission power selector 7 increases the transmission power.

The methods of deciding the modulation scheme, the coding rate and the transmission power are not limited to the method shown in FIG. 2. Instead of deciding the modulation scheme, the coding rate and the transmission power based on the difference between the highest likelihood and the other likelihoods, determination may be carried out based on a ratio of the highest likelihood to the other likelihoods. In this case, the modulation scheme, the coding rate and the transmission power may be decided by whether the ratio is larger than a prescribed reference value.

Although the most probable likelihood is compared with the average value of the other likelihoods in FIG. 2, the relative likelihood may be calculated by comparing with a maximum value and a minimum value of the other likelihoods, instead of the average value.

As shown in a dotted line in FIG. 1, a memory 20 which stores selection results of the modulation scheme selector 5, the coding rate selector 6 and the transmission power selector 7 may be provided in the first communication device 1. When a prescribed time is passed or a prescribed condition is satisfied, the selection of the modulation scheme selector 5, the coding rate selector 6 and the transmission power selector 7 may be switched, and contents in the memory 20 may be updated in accordance with the switching.

Therefore, if necessary, it is possible to read out from the memory 20 the modulation scheme, the coding rate and the transmission power in order to set them, thereby shortening a time required for setting the transmission parameters.

Thus, according to the first embodiment, the modulation scheme, the coding rate and the transmission power in the case of transmitting data from the first communication device 1 to the second communication device 2 through the second communication channel L2 are selected, based on the signal reached the first communication device 1 from the second communication device 2 to the first communication device 1 through the first communication channel L1. Because of this, it is possible to set transmission parameters with the best transmission efficiency, thereby improving transmission speed per unit time, i.e. improving transmission throughput. Even if a transfer characteristic fluctuates, it is possible to set new modulation scheme, coding rate and transmission power, taking the fluctuation component into consideration. Because of this, even if the transfer characteristic fluctuates, there are no influences due to fluctuation of the transfer characteristic.

Especially, according to the present embodiment, influences due to the distortions of the first and second communication devices 1 and 2, the distortions of the first and second communication channels L1 and L2 and the noise are totally determined to select a proper modulation scheme, a proper coding rate and a proper transmission power. Therefore, it is possible to surely improve transmission throughput, compared with conventional techniques which does not totally determine influences due to such kind of the distortions.

Furthermore, because it is possible to set a proper transmission power, it is possible to restrict interference for the other stations.

In the case of the present embodiment, the transfer characteristic of the second communication channel L2 is decided based on the transfer characteristic of the first communication channel L1. Because of this, it is desirable that the transfer characteristics of the first and second communication channels L1 and L2 are the same or similar. More specifically, it is desirable to coincide a distance between the first and second communication channels L1 and L2 with locations. It is desirable that the coding method used by the first communication device 1 at transmission time and the coding method used by the second communication device 2 at transmission time are the same or similar, because transmission throughput changes when the coding methods are different.

### Second Embodiment

In a second embodiment, the second communication device sets transmission parameter in accordance with the transmission parameter decided by the first communication device.

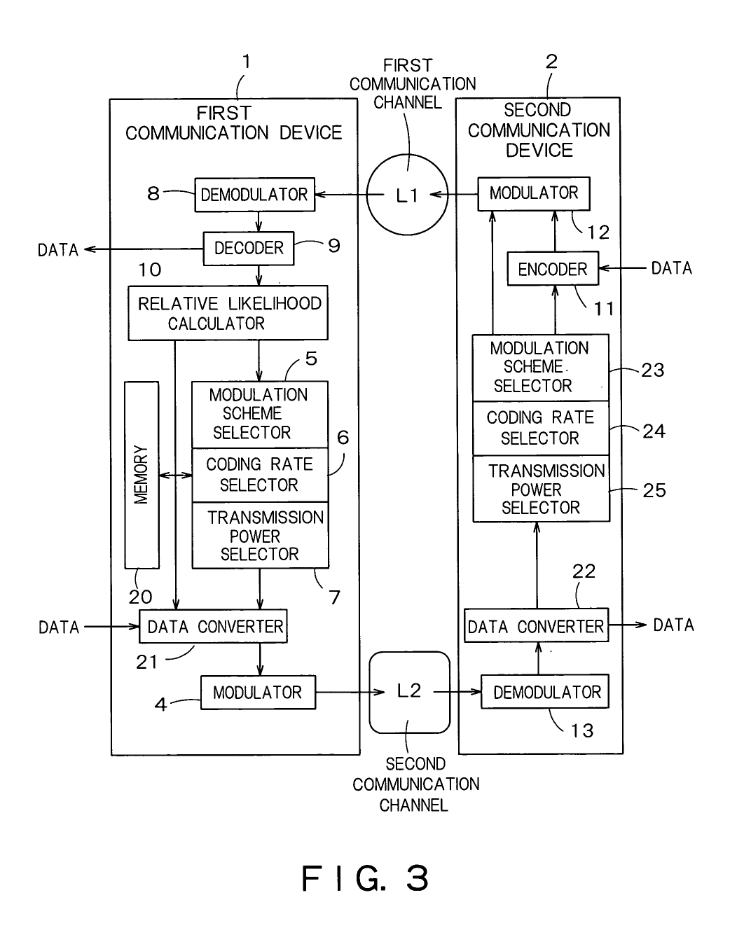

FIG. 3 is a block diagram showing schematic configuration according to the second embodiment of a digital communication system of the present invention. In FIG. 3, the same reference numbers are attached to constituents common to FIG. 1. Hereinafter, differences from FIG. 1 will be mainly described.

The digital communication system of FIG. 3 has first and second communication devices 1 and 2 which transmit and receive data to each other through the first and second communication channels L1 and L2.

The first communication device 1 of FIG. 3 has a data converter 21, instead of the encoder 3 of FIG. 1. The data converter 21 combines the relative likelihood calculated by the relative likelihood calculator 10 or the selection information of the modulation scheme selector 5, the coding rate selector 6 and the transmission power selector 7 with data from outside.

Data combined by the data converter 21 is modulated by the modulator 4, and transmitted to the second communication device 2 through the first communication channel L1.

The second communication device 2 of FIG. 3 has a data converter 22, instead of the decoder 14 of FIG. 1. Besides that, the second communication device 2 has a modulation scheme selector 23, a coding rate selector 24 and a transmission power selector 25.

The data converter 21 extracts the relative likelihood or the selection information of the modulation scheme selector 5, the coding rate selector 6 and the transmission power selector 7 in the first communication device 1, among data transmitted from the first communication device 1. The modulation scheme selector 23, the coding rate selector 24 and the transmission power selector 25 in the second communication device 2 select at least one of the modulation scheme, the coding rate and the transmission power in the case of transmitting data from the second communication device 2 to the first communication device 1.

Therefore, the second communication device 2 can set the transmission parameter which conforms to the transmission parameter set by the first communication device 1.

Thus, according to the second embodiment, the transmission parameter is decided based on the relative likelihood calculated by the first communication device 1 or the selection information of the modulation scheme, the coding rate and the transmission power selected by the first communication device 1. Because of this, it is possible to conform the transmission parameter of the first communication device 1 to the second communication device 2, thereby improving transmission throughput. Furthermore, according to the second embodiment, it is possible to select more proper modulation scheme, coding rate and transmission power, thereby restricting interference from the other communication device.

1. A digital communication device, comprising:
a decoder which calculates likelihoods indicative of probability in which a signal received from another communication device corresponds to a plurality of signal sequences;
a relative likelihood calculator which calculates a relative likelihood expressing differences and ratios between the most probable likelihood among the calculated likelihoods and the other likelihoods; and
a transmission parameter deciding unit which decides a transmission parameter composed of at least one of modulation scheme, a coding rate and a transmission power for a signal to be transmitted at next time, based on the calculated relative likelihood.

2. The digital communication device according to claim 1, wherein said transmission parameter deciding unit calculates the relative likelihood expressing a difference and a ratio between the most probable likelihood and at least one of an average value, a maximum value and a minimum value of the other likelihoods.

3. The digital communication device according to claim 1, wherein said transmission parameter deciding unit includes:
a modulation scheme selector which selects the modulation scheme of the signal to be transmitted at next time based on the calculated relative likelihood;
a coding rate selector which selects the coding rate of the signal to be transmitted at next time based on the calculated relative likelihood; and
a transmission power selector which selects the transmission power of the signal to be transmitted at next time based on the calculated relative likelihood.

4. The digital communication device according to claim 3, further comprising a memory which stores result selected by said modulation scheme selector, said coding rate selector and said transmission power selector;
wherein said modulation scheme selector, said coding selector and said transmission power selector switch the selected contents, and said memory updates the stored contents, when a prescribed time is passed, or a prescribed condition is satisfied.

5. The digital communication device according to claim 3, further comprising:
an encoder which codes a signal to be transmitted to the other communication devices based on the coding rate selected by said coding rate selector; and
a modulator which modulates a signal coded by said encoder and transmits the modulated signal with transmission power selected by said transmission power selector based on the modulation scheme selected by said modulation scheme selector.

6. The digital communication device according to claim 1, further comprising a data converter which transmits a signal to be transmitted to the other communication device which has transmitted the received signal, including the transmission parameter decided by said transmission parameter deciding unit.

7. The digital communication apparatus according to claim 1, further comprising a demodulator which demodulates the received signal transmitted from the other communication device,
wherein said decoder decides whether or not the signal demodulated by said demodulator corresponds to any of said plurality of signal sequences; and
said relative likelihood calculator calculates the relative likelihood based on a result decoded by said decoder.

8. A digital communication apparatus, comprising:
a transmitter which transmits a signal to another communication device;
a receiver which receives data including a transmission parameter composed of at least one of modulation scheme, a coding rate and a transmission power used when said other communication devices transmit the signal at next time, said transmission parameter being decided by the other communication device based on the signal; and
a transmission parameter deciding unit which decides at least ones of the modulation scheme, the coding rate and the transmission power to be transmitted to the other communication device at next time, based on the transmission parameter included in the received signal.

9. The digital communication apparatus according to claim 8, further comprising a data converter which extracts said transmission parameter from the signal received by said receiver,
wherein said transmission parameter deciding unit decides at least one of the modulation scheme, the coding rate and the transmission power of the signal to be transmitted to the other communication device at next time, based on the extracted transmission parameter.

10. A digital communication system comprising first and second communication devices which transmit and receive a signal to each other through first and second communication channels, wherein at least one of said first and second communication devices includes:
a decoder which calculates a likelihood indicative of a probability in which a signal received from another communication device corresponds to candidates of a plurality of signal sequences, respectively;
a relative likelihood calculator which calculates a relative likelihood expressing differences and ratios between the most probable likelihood among the calculated likelihoods and other likelihoods; and
a transmission parameter deciding unit which decides a transmission parameter composed of at least one of modulation scheme, a coding rate and a transmission power of a signal to be transmitted to the other communication device at next time.

11. A digital communication system comprising first and second communication devices which transmit and receive a signal to each other through a first and second communication channel,
wherein said first communication device includes:
a first decoder which calculates likelihoods indicative of a probability in which a signal received from said second communication device through said first communication channel corresponds to candidates of a plurality of signal sequences;
a relative likelihood calculator which calculates a relative likelihood expressing differences and ratios between the most probable likelihood among the calculated likelihood and other likelihoods;
a transmission parameter deciding unit which decides a transmission parameter composed of at least one of modulation scheme, a coding ratio and a transmission power of a signal to be transmitted to a second communication device at next time, based on the calculated relative likelihood;
a first encoder which codes a signal to be transmitted to said second communication device through said second communication device; and
a first modulator which modulates the signal coded by said first encoder, based on the transmission parameter decided by said transmission parameter deciding unit;
said second communication device includes:
a second decoder which decodes the signal received from said first communication device through said second communication channel;
a second encoder which codes a signal to be transmitted to said first communication device through said second communication channel; and
a second modulator which modulates the signal coded by said second encoder.

12. The digital communication system according to claim 11, wherein said transmission parameter deciding unit decides at least one of the modulation scheme, the coding rate and the transmission power of the signal to be transmitted at next time, by using at least one of an average value, a maximum value and a minimum value of the relative likelihood for candidates of a plurality of signal sequences.

13. The digital communication system according to claim 11, wherein said transmission parameter deciding unit includes:
a modulation scheme selector which selects the modulation scheme of the signal to be transmitted at next time, based on the calculated relative likelihood;
a coding rate selector which selects the coding rate of the signal to be transmitted at next time, based on the calculated relative likelihood; and
a transmission power selector which selects the transmission power of the signal to be transmitted at next time, based on the calculated relative likelihood.

14. The digital communication system according to claim 11, further comprising a memory which stores a result selected by said modulation scheme selector, said coding rate selector and said transmission power selector, said memory being provided in said first communication device,
wherein said modulation scheme selector, said coding rate selector and said transmission power selector switch the selections, and said memory updates the stored contents, when a prescribed time is passed, or a prescribed condition is satisfied.

15. A digital communication system composing first and second communication apparatuses which transmit and receive data to each other through first and second communication channel,
wherein said first communication apparatus includes:
a first decoder which calculates likelihoods indicative of probability in which a signal received from another communication device corresponds to candidates of a plurality of signal sequences;
a relative likelihood calculator which calculates a relative likelihood expressing differences and ratio between the most probable likelihood among the calculated likelihood and the other likelihoods;
a first transmission parameter deciding unit which decides a transmission parameter composed of at least one of modulation scheme, a coding ratio and a transmission power of a signal to be transmitted to the other communication device; and
a first transmitter which transmits data including the decided transmission parameter, through said other communication channel on the transmission parameter decided by said first transmission parameter deciding unit,
said other communication device includes:
a transmission parameter extracting unit which extracts the transmission parameter included in data transmitted from said first communication device through said second communication channel;
a second transmission parameter deciding unit which decides the transmission parameter in the case of transmitting data to said first communication device through said first communication channel; and
a second transmitter which transmits data on the transmission parameter decided by said second transmission parameter deciding unit through said first communication channel.

16. The digital communication system according to claim 15, wherein said transmission parameter deciding unit decides at least one of the modulation scheme, the coding rate and the transmission power of the signal to be transmitted at next time, by using at least one of an average value, a maximum value and a minimum value of relative likelihoods for candidates of a plurality of signal sequences.

17. The digital communication system according to claim 15, wherein said transmission parameter deciding unit includes:
a modulation scheme selector which selects the modulation scheme of the signal to be transmitted at next time, based on the calculated relative likelihood;
a coding rate selector which selects the coding rate of the signal to be transmitted at next time, based on the calculated relative likelihood; and
a transmission power selector which selects the transmission power of the signal to be transmitted at next time, based on the calculated relative likelihood.

18. The digital communication system according to claim 17, further comprising a memory which stores results selected by said modulation scheme selector, said coding rate selector and said transmission power selector,
wherein said modulation scheme selector, said coding rate selector and said transmission power selector switch the selected contents, and said memory updates the stored contents, when a prescribed time is passed or a prescribed condition is satisfied.

19. The digital communication system according to claim 10, wherein said first and second communication channels have the same or similar transmission properties.
